(19) United States
(12) Patent Application Publication
(10) Pub. No.: US 2025/0338877 A1
(43) Pub. Date: Nov. 6, 2025

(54) SUNFLOWER SEED FOOD AND BEVERAGE COMPOSITIONS AND RELATED METHODS OF PREPARING

(71) Applicant: Lattini, Inc., Geneva, NY (US)

(72) Inventors: Nicholas Romano, Geneva, NY (US); Jared Lynch, Geneva, NY (US)

(21) Appl. No.: 18/871,431

(22) PCT Filed: Jun. 12, 2023
(86) PCT No.: PCT/US2023/068265

§ 371 Date: Dec. 3, 2024

Related U.S. Application Data
(60) Provisional application No. 63/351,247, filed on Jun. 10, 2022.

(51) Int. Cl. A23L 2/38; A23B 2/20; A23B 70/30; A23L 2/56; A23L 2/60; A23L 2/70

(52) U.S. Cl. CPC A23L 2/38; A23B 2/20; A23B 70/30; A23L 2/56; A23L 2/60; A23L 2/70

(57) ABSTRACT

Example sunflower seed food and beverage compositions and related methods of preparing are described. In an embodiment, a method of preparing a sunflower seed beverage composition includes heat treating hulled sunflower seeds at a temperature of about 10° C. to about 150° C. for about 1 minute to about 45 minutes, comminuting the heat treated sunflower seeds, mixing water with the heat treated and comminuted sunflower seeds to form a composition, pasteurizing the composition, and homogenizing the composition to form the sunflower seed beverage composition.

### CROSS-REFERENCE TO RELATED APPLICATIONS

This application claims priority to U.S. Provisional Patent Application No. 63/351,247, titled “Sunflower Seed Food and Beverage Compositions and Related Methods of Preparing,” filed on Jun. 10, 2022, the disclosure of which is incorporated herein, in its entirety, by this reference.

### BACKGROUND

Improved non-dairy milk-type products are sought by many consumers.

### SUMMARY

Embodiments disclosed herein are sunflower seed food and beverage compositions, and related methods of preparing. In an embodiment, a method of preparing a sunflower seed beverage composition includes heat treating hulled sunflower seeds at a temperature of about 10° C. to about 150° C. for about 5 minutes to about 45 minutes. The method also includes comminuting the heat treated sunflower seeds. The method also includes mixing water with the heat treated and comminuted sunflower seeds to form a composition. The method also includes pasteurizing the composition. The method also includes homogenizing the composition to form the sunflower seed beverage composition.

In an embodiment, a sunflower seed beverage composition is disclosed. The sunflower seed beverage composition includes about 0.1 wt % to about 14.9 wt % heat treated and comminuted sunflower seeds, about 81 wt % to about 99.9 wt % water, a pH of about 7.1 to about 8.0, and at least one of an anti-caking agent, a gelling agent, a sweetener, one or more vitamins, and/or one or more natural flavors.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is a flow diagram of a method of preparing a sunflower seed beverage composition, according to an embodiment.

### DETAILED DESCRIPTION

Embodiments disclosed herein are sunflower seed food and beverage compositions, and related methods of preparing sunflower seed food and beverage compositions. The sunflower seed food and/or beverage compositions include one or more of non-dairy milk-type and/or a non-dairy milk-type base for a beverage, a gelato, a curd, a butter, a yogurt or fermented food product, a pudding, a cheese-type product, a cream cheese-type product, and/or a plant-based meat replacement products. Generally, the sunflower seed food and/or beverage compositions includes at least milled (or ground) sunflower seeds and water. In an example, a sunflower seed (non-dairy) milk-type beverage composition includes milled (or ground) sunflower seeds, water, and 2% or less of natural flavor, calcium carbonate, vitamin D2, riboflavin, vitamin B12, sunflower lecithin, dipotassium phosphate, sea salt, and/or gellan gum. The method of producing a sunflower seed food and/or beverage compositions includes milling (or grinding) a sunflower seed kernel and mixing the milled or ground sunflower kernel with water to form a butter or paste. This butter or paste may be mixed with additional water to form the sunflower seed food and/or beverage compositions. In an example, the butter or paste from the ground or milled sunflower seed kernels is mixed with water and 2% or less of at least one of natural flavor, calcium carbonate, vitamin D2, riboflavin, vitamin B12, sunflower lecithin, dipotassium phosphate, sea salt, and/or gellan gum to form a sunflower seed (non-dairy) milk composition. The sunflower seed food and/or beverage compositions may be further treated with one or more of ultra-high temperature (UHT) pasteurization.

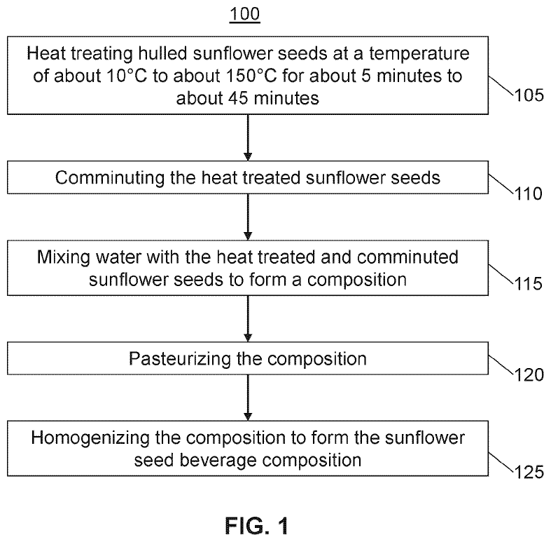

Turning to FIG. 1, a method 100 of preparing a sunflower seed beverage composition is disclosed, according to an embodiment. In some embodiments, the method 100 includes selecting hulled sunflower seeds having one or more predetermined properties that allow the hulled sunflower seeds to be roasted (e.g., heat treated) and milled to a predetermined and desired specification. For example, the method 100 may include selecting sunflower seeds that are a hybrid between oilseed and confectionary seeds that contain mid-to high-oleic acid or oil content. The oil content of the hulled sunflower seeds also allows the sunflower seed beverage composition to be prepared without the addition of any processing aids or oils during processing. In other words, only the oils found in hulled sunflower seeds may be present the sunflower seed beverage composition formed according to the method 100, and any additional oils besides those oils found in the hulled sunflowers seeds may be absent from the sunflower seed beverage composition. In some embodiments, the hulled sunflower seeds have a total oil content of about 20 wt % to about 60 wt %, about 20 wt % to about 40 wt %, about 30 wt % to about 50 wt %, about 40 wt % to about 60 wt %, about 20 wt % to about 30 wt %, about 25 wt % to about 35 wt %, about 30 wt % to about 40 wt %, about 35 wt % to about 45 wt %, about 40 wt % to about 50 wt %, about 45 wt % to about 55 wt %, or about 50 wt % to about 60 wt %.

The oil present in the hulled sunflower seeds may include at least one (e.g., one or both) of oleic acid and linoleic acid. In some embodiments, the oleic acid content of the total oil in the hulled sunflower seeds is about 22 wt % to about 88 wt % oleic acid, and the linoleic acid content of the total oil in the hulled sunflower seeds is about 2 wt % to about 62 wt % linoleic acid. The content of oleic acid and/or linoleic acid in the hulled sunflower seeds act not only nutritionally as a replacement to saturated fat, but also contributes to one or more (e.g., all) of the creaminess, viscosity, and/or foaming ability of the beverage.

In more particular embodiments, the hulled sunflower seeds can have an oleic acid content of about 20 wt % to about 90 wt %, about 20 wt % to about 55 wt %, about 55 wt % to about 90 wt %, about 20 wt % to about 35 wt %, about 35 wt % to about 50 wt %, about 50 wt % to about 65 wt %, about 65 wt % to about 80 wt %, about 80 wt % to about 90 wt %, about 20 wt % to about 30 wt %, about 30 wt % to about 40 wt %, about 40 wt % to about 50 wt %, about 50 wt % to about 60 wt %, about 60 wt % to about 70 wt %, about 70 wt % to about 80 wt %, about 80 wt % to about 90 wt %, about 20 wt % to about 25 wt %, about 25 wt % to about 30 wt %, about 30 wt % to about 35 wt %, about 35 wt % to about 40 wt %, about 40 wt % to about 45 wt %, about 45 wt % to about 50 wt %, about 50 wt % to about 55 wt %, about 55 wt % to about 60 wt %, about 60 wt % to about 65 wt %, about 65 wt % to about 70 wt %, about 70 wt % to about 75 wt %, about 75 wt % to about 80 wt %, about 80 wt % to about 85 wt %, about 85 wt % to about 90 wt %, at least about 20 wt %, at least about 25 wt %, at least about 30 wt %, at least about 35 wt %, at least about 40 wt %, at least about 45 wt %, at least about 50 wt %, at least about 55 wt %, at least about 60 wt %, at least about 65 wt %, at least about 70 wt %, at least about 75 wt %, at least about 80 wt %, or at least about 85 wt % of the total oil in the hulled sunflower seeds.

In more particular embodiments, the hulled sunflower seeds may have any of the oleic acid contents described above and may have a linoleic acid content of about 2 wt % to about 62 wt %, about 2 wt % to about 32 wt %, about 32 wt % to about 62 wt %, about 2 wt % to about 17 wt %, about 17 wt % to about 32 wt %, about 35 wt % to about 47 wt %, about 47 wt % to about 62 wt %, about 2 wt % to about 12 wt %, about 12 wt % to about 22 wt %, about 22 wt % to about 32 wt %, about 32 wt % to about 42 wt %, about 42 wt % to about 52 wt %, about 52 wt % to about 62 wt %, about 2 wt % to about 7 wt %, about 7 wt % to about 12 wt %, about 12 wt % to about 17 wt %, about 17 wt % to about 22 wt %, about 22 wt % to about 27 wt %, about 27 wt % to about 32 wt %, about 32 wt % to about 37 wt %, about 37 wt % to about 42 wt %, about 42 wt % to about 47 wt %, about 47 wt % to about 52 wt %, about 52 wt % to about 57 wt %, about 57 wt % to about 62 wt %, at least about 5 wt %, at least about 10 wt %, at least about 15 wt %, at least about 20 wt %, at least about 25 wt %, at least about 30 wt %, at least about 35 wt %, at least about 40 wt %, at least about 45 wt %, at least about 50 wt %, at least about 55 wt %, or at least about 60 wt % of the total oil in the hulled sunflower seeds.

The method 100 may include roasting (e.g., heat treating) 105 hulled sunflower seeds at a temperature of about 50° F. to about 300° F. (or about 10° C. to about 150° C.) for about 1 minute to about 45 minutes, comminuting 110 the roasted (e.g., heat treated) sunflower seeds, mixing 115 water with the roasted and comminuted sunflower seeds to form a composition, pasteurizing 120 the composition, and homogenizing 125 the composition to form the sunflower seed beverage composition. Roasting 105 sunflower seeds may include various forms of heat treatment. Accordingly, reference to roasting or roasted sunflower seeds may include heat treating or heat treated sunflower seeds herein. In some embodiments, the method 100 of preparing a sunflower seed beverage composition also includes removing hulls from the sunflower seeds (e.g., hulling) before roasting the hulled sunflower seeds.

Roasting (e.g., heat treating) 105 the hulled sunflower seeds may vary according to different embodiments. In some embodiments, roasting 105 the hulled sunflower seeds includes roasting 105 the hulled sunflower seeds at a temperature of about 50° F. to about 400° F. (or about 10° C. to about 205° C.), about 50° F. to about 150° F. (or about 10° C. to about 65° C.), about 150° F. to about 250° F. (or about 65° C. to about 120° C.), about 250° F. to about 350° F. (or about 120° C. to about 175° C.), about 50° F. to about 100° F. (or about 10° C. to about 40° C.), about 100° F. to about 150° F. (or about 40°° C. to about 65° C.), about 150° F. to about 200° F. (or about 65° C. to about 95° C.), about 200° F. to about 250° F. (or about 95° C. to about 120° C.), about 250° F. to about 300° F. (or about 120° C. to about 150° C.), about 300° F. to about 350° F. (or about 150° C. to about 175° C.), about 350° F. to about 400° F. (or about 175° C. to about 205° C.), at least about 50° F. (or at least about 10° C.), at least about 100° F. (or at least about 40° C.), at least about 150° F. (or at least about 65° C.), at least about 200° F. (or at least about 95° C.), at least about 250° F. (or at least about 120° C.), or at least about 300° F. (or at least about 150° C.). The roasting time and temperatures provided herein result in the technical effect of providing selected characteristics (e.g., organoleptic characteristics) of the seeds and beverage. Conventional processing of sunflower seeds includes longer roasting times and higher roasting temperatures to provide a “ready to eat product” having a vastly different flavor profile. The roasting times and temperatures described herein, however, achieve the distinct organoleptic attributes targeted in the beverage.

Furthermore, conventional processing of sunflower seed compositions include the addition of another vegetable oil, such as sunflower oil, safflower oil, and/or rapeseed/canola oil. In contrast, the act of adding one or more (e.g., all) of sunflower oil, safflower oil, and/or rapeseed/canola oil may be absent from the method 100. The composition formed according to the method 100 also may be devoid of one or more (e.g., all) of safflower oil and/or rapeseed/canola oil. In some embodiments, organoleptic attributes may be achieved by not adding any other oils to the base or composition, such that the oil content in the base or composition comes solely and entirely from the sunflower seeds heat treated and comminuted according to the method 100.

In some embodiments, roasting 105 the hulled sunflower seeds includes roasting the hulled sunflower seeds at any of the temperatures described above for about 1 minute to about 60 minutes, about 1 minute to about 30 minutes, about 30 minutes to about 60 minutes, about 1 minute to about 15 minutes, about 15 minutes to about 30 minutes, about 30 minutes to about 45 minutes, about 45 minutes to about 60 minutes, about 1 minute to about 10 minutes, about 5 minutes to about 15 minutes, about 15 minutes to about 25 minutes, about 25 minutes to about 35 minutes, about 35 minutes to about 45 minutes, about 45 minutes to about 55 minutes, at least about 5 minutes, at least about 15 minutes, at least about 25 minutes, at least about 35 minutes, at least about 45 minutes, at least about 55 minutes, less than about 60 minutes, less than about 50 minutes, less than about 40 minutes, less than about 30 minutes, less than about 20 minutes, less than about 10 minutes, or less than about 5 minutes.

In some embodiments, comminuting 110 the roasted sunflower seeds includes comminuting 110 the roasted sunflower seeds to pieces of about 10 microns to about 60 microns, about 10 microns to about 30 microns, about 20 microns to about 40 microns, about 30 microns to about 50 microns, about 40 microns to about 60 microns, about 10 microns to about 20 microns, about 20 microns to about 30 microns, about 30 microns to about 40 microns, about 40 microns to 10 about 50 microns, about 50 microns to about 60 microns, less than about 50 microns, less than about 40 microns, less than about 30 microns, less than about 20 microns, or less than about 10 microns. The size/dimensions of the comminuted sunflower seeds provides smooth mouthfeel and inhibits or prevents immediate settling of the comminuted material in the final beverage. The size/dimensions of the comminuted sunflower seeds also provides more overall surface area to allow other ingredients to more efficiently coat the protein in the comminuted sunflower seeds. Comminuting 110 the roasted sunflower seeds may include any of a number of different types of comminuting, such as milling, grinding, crushing, and/or pulverizing.

In some embodiments of the method 100 of preparing the sunflower seed beverage composition, mixing 115 water with the roasted and comminuted sunflower seeds to form a composition includes mixing 115 water with the roasted and comminuted sunflower seeds to form a composition having about 0.1 wt % to about 14.9 wt % comminuted sunflower seeds and about 81 wt % to about 99.9 wt % water. More particularly, water may be mixed with the roasted and comminuted sunflower seeds to form a composition having about 0.1 wt % to about 5 wt %, about 5 25 wt % to about 14.9 wt %, about 0.1 wt % to about 2.5 wt %, about 2.5 wt % to about 5 wt %, about 5 wt % to about 7.5 wt %, about 7.5 wt % to about 10 wt %, about 10 wt % to about 12.5 wt %, about 12.5 wt % to about 14.9 wt %, at least about 0.1 wt %, at least about 2.5 wt %, at least about 5 wt %, at least about 7.5 wt %, at least about 10 wt %, at least about 12.5 wt %, at least about 14.9 wt %, less than about 15 wt %, less than about 12.5 wt %, less than about 10 wt %, less than about 7.5 wt %, less 30 than about 5 wt %, less than about 2.5 wt %, less than about 2 wt %, less than about 1.5 wt %, less than about 1 wt %, or less than about 0.5 wt % comminuted sunflower seeds.

In some embodiments, water may be mixed with the roasted and comminuted sunflower seeds to form a composition having about 81 wt % to about 99.9 wt %, about 81 wt % to about 90 wt %, about 90 wt % to about 99.9 wt %, about 81 wt % to about 85 wt %, about 85 wt % to 35 about 90 wt %, about 90 wt % to about 95 wt %, about 95 wt % to about 99.9 wt %, at least about 81 wt %, at least about 85 wt %, at least about 90 wt %, at least about 95 wt %, at least about 99 wt %, less than about 100 wt %, less than about 95 wt %, less than about 90 wt %, less than about 85 wt %, or less than about 82 wt % water.

In some embodiments, the composition formed according to the method 100 is a sunflower seed beverage base composition and, as such, may include less water than to described above, or the act of mixing 115 water with the roasted (e.g., heat treated) and comminuted sunflower seeds may be absent (e.g., no water is added to the roasted and comminuted sunflower seeds). In these and other embodiments, the resulting composition may be packaged and distributed for the consumer to add a desired or predetermined amount of water to the composition before use. In these and other embodiments, mixing 115 water with the heat treated and comminuted sunflower seeds may include mixing 115 water with the heat treated and comminuted sunflower seeds to form a composition having less than about 60 wt %, less than about 50 wt %, less that about 40 wt %, less than about 30 wt %, less than about 20 wt %, or less than about 10 wt % water.

In some embodiments of the method 100 of preparing the sunflower seed beverage composition, mixing 115 water with the roasted and comminuted sunflower seeds to form a composition includes mixing a first amount of the water to the comminuted sunflower seeds to form a paste and then mixing a second amount of the water to the paste to form the composition. One or more (e.g., all) of the other materials (e.g., an anti-caking agent, a gelling agent, a sweetener, one or more vitamins, and/or one or more natural flavors) in the beverage composition described herein may be added to the paste before the paste is mixed with the second amount of the water. One or more (e.g., all) of the other materials (e.g., an anti-caking agent, a gelling agent, a sweetener, one or more vitamins, and/or one or more natural flavors) in the beverage composition described herein may be added to the composition after the paste is mixed with the second amount of the water.

In some embodiments of the method 100 of preparing the sunflower seed beverage composition, the method 100 may include an act of adding a pH buffer to the composition to such that the composition has a pH of about 7.1 to about 8.0, about 7.1 to about 7.5, or about 7.5 to 8. The pH buffer may be added before pasteurizing and homogenizing the composition (described below). In some embodiments, the pH buffer includes at least one of dipotassium phosphate or potassium citrate. In some embodiments, the pH buffer includes other pH buffers used in the food and beverage industry. The pH buffer may be added to the composition in an amount of less than about 2 wt %, less than about 1.5 wt %, less than about 1 wt %, less than about 0.5 wt %, or less than about 0.25 wt % of the sunflower seed beverage composition.

In some embodiments of the method 100 of preparing the sunflower seed beverage composition, the method 100 may include an act of mixing the composition with a gelling agent to provide a selected or desired mouthfeel and/or at least temporarily suspend particles equally through the beverage composition. The gelling agent may be added before pasteurizing and homogenizing the composition (described below). In some embodiments, the gelling agent includes at least one of gellan gum, xantham gum, guar gum, gum Arabic (e.g., Acacia gum). In some embodiments, the gelling agent includes other gums or gelling agents used in the food and beverage industry. The gelling agent may be added to the composition in an amount of less than about 2 wt %, less than about 1.5 wt %, less than about 1 wt %, less than about 0.5 wt %, or less than about 0.25 wt % of the sunflower seed beverage composition.

In some embodiments of the method 100 of preparing the sunflower seed beverage composition, the method 100 may include an act of mixing the composition with at least one (e.g., all) of a sweetener, one or more vitamins, a food-grade phosphate, and/or one or more natural flavors. These materials may be added before pasteurizing and homogenizing the composition (described below). At least one of a sweetener, one or more vitamins, and/or one or more natural flavors may include at least one (e.g., all) of vitamin D2, riboflavin, vitamin B12, salt (e.g., sea salt). The food-grade phosphate may bind to copper, a naturally occurring mineral in sunflower seeds, to prevent product discoloration and inhibit greening. Each of the at least one of a sweetener, one or more vitamins, food-grade phosphate, and/or one or more natural flavors may be included in an amount of less than about 2 wt %, less than about 1.5 wt %, less than about 1 wt %, less than about 0.5 wt %, or less than about 0.25 wt % of the sunflower seed beverage composition.

The composition also may undergo ultra-high temperature pasteurization (UHT) and/or high temperature short time pasteurization (HTST). In some embodiments of the method 100 of preparing the sunflower seed beverage composition, pasteurizing 120 the composition includes pasteurizing the composition at about 270° F. to about 300° F. for about 2 seconds to about 6 seconds. More particularly, the composition may be pasteurized at about 260° F. to about 310° F., about 270° F. to about 285° F., about 285° F. to about 300° F., about 270° F. to about 280° F., about 280° F. to about 290° F., about 290° F. to about 300° F., at least about 260° F., at least about 270° F., at least about 280° F., at least about 290° F., at least about 300° F., less than about 310° F., less than about 300° F., less than about 290° F., less than about 280° F., or less than about 270° F. In some embodiments, the composition may be pasteurized at any of the temperatures provided above for about 1 second to about 8 seconds, about 2 seconds to about 6 seconds, about 2 seconds to about 4 seconds, about 4 seconds to about 6 seconds, about 2 seconds to about 3 seconds, about 3 seconds to about 4 seconds, about 4 seconds to about 5 seconds, about 5 seconds to about 6 seconds, at least about 2 seconds, at least about 3 seconds, at least about 4 seconds, at least about 5 seconds, at least about 6 seconds, less than about 6 seconds, less than about 5 seconds, less than about 4 seconds, less than about 3 seconds, or less than about 2 seconds. By using the higher temperature and longer time for UHT processing, the beverage may be packaged aseptically and unopened, and can achieve at least 1 year of shelf-life without refrigeration at ambient temperatures.

In some embodiments of the method 100 of preparing the sunflower seed beverage composition, homogenizing 125 the composition may include homogenizing 125 the composition in multiple phases. For example, the composition may be homogenized in a first phase and a second phase. In some embodiments, the method includes homogenizing the composition at a first phase of about 1900 psi (pounds per square inch) to about 2300 psi, about 2000 psi to about 2200 psi, about 2000 psi to about 2100 psi, about 2100 psi to about 2200 psi, at least about 2000 psi, at least about 2100 psi, at least about 2200 psi, less than about 2200 psi, less than about 2100 psi, or less than about 2000 psi. In some embodiments, the method 100 may include homogenizing the composition at a second phase after homogenizing the composition at the first phase. The second phase of homogenization may be at about 400 psi to about 1200 psi, about 500 psi to about 1000 psi, about 500 psi to about 750 psi, about 750 psi to about 1000 psi, about 500 psi to about 600 psi, about 600 psi to about 700 psi, about 700 psi to about 800 psi, about 800 psi to about 900 psi, about 900 psi to about 1000 psi, at least about 500 psi, at least about 600 psi, at least about 700 psi, at least about 800 psi, at least about 900 psi, at least about 1000 psi, less than about 1000 psi, less than about 900 psi, less than about 800 psi, less than about 700 psi, less than about 600 psi, or less than about 500 psi.

The sunflower seed beverage composition also may be packaged into bottles or cartons. In some embodiments, the method 100 also includes an act of dispensing or distributing the sunflower seed beverage composition in at least one of a polyethylene terephthalate (PET) bottle, an extended shelf-life container, and/or an aseptic container. For example, the sunflower seed beverage composition may be aseptically packaged in various containers.

Acts of the method 100 of preparing the sunflower seed beverage composition may be performed in different orders, split into multiple acts, modified, supplemented, or combined. In an embodiment, one or more of the acts of the method 100 of preparing the sunflower seed beverage composition may be omitted from the method.

Also described herein is a sunflower seed beverage composition including roasted and comminuted sunflower seeds, water, a pH of about 7.1 to about 8.0, and at least one of an anti-caking agent, a gelling agent, a sweetener, one or more vitamins, and/or one or more natural flavors. The amount of roasted and comminuted sunflower seeds in the sunflower seed beverage composition may include any of the amounts of roasted and comminuted sunflower seeds provided above in examples of the method of preparing the sunflower seed beverage composition, such as an amount of about 0.1 wt % to about 14.9 wt % roasted and comminuted sunflower seeds in the sunflower seed beverage composition. For example, the sunflower seed beverage composition may include about 0.1 wt % to about 5 wt %, about 5 wt % to about 10 wt %, about 10 wt % to about 14.9 wt %, about 0.1 wt % to about 3 wt %, about 3 wt % to about 6 wt %, about 6 wt % to about 9 wt %, about 9 wt % to about 12 wt %, about 12 wt % to about 14.9 wt %, about 0.1 wt % to about 1 wt %, about 1 wt % to about 2 wt %, about 2 wt % to about 3 wt %, about 3 wt % to about 4 wt %, about 4 wt % to about 5 wt %, about 5 wt % to about 6 wt %, about 6 wt % to about 7 wt %, about 7 wt % to about 8 wt %, about 8 wt % to about 9 wt %, about 9 wt % to about 10 wt %, about 10 wt % to about 11 wt %, about 11 wt % to about 12 wt %, about 12 wt % to about 13 wt %, about 13 wt % to about 14 wt %, or about 14 wt % to about 14.9 wt % roasted and comminuted sunflower seeds.

The roasted and comminuted sunflower seeds in the sunflower seed beverage composition may be treated or processed as described above in the method of preparing the sunflower seed beverage composition, such as roasting a temperature of about 50° F. to about 300° F. for about 5 minutes to about 45 minutes and comminuting the roasted sunflower seeds to sizes of about 20 microns to about 60 microns before mixing with the water.

The sunflower seed beverage composition also may include a total oil content. The entirety of the oil in the total oil content in the sunflower seed beverage composition may come from or be derived from the comminuted and roasted sunflower seeds. In some embodiments, the total oil content in the sunflower seed beverage composition may be about 0.02 wt % to about 8.9 wt %, about 0.02 wt % to about 4.5 wt %, about 4.5 wt % to about 9 wt %, about 0.02 wt % to about 2 wt %, about 1 wt % to about 3 wt %, about 2 wt % to about 4 wt %, about 3 wt % to about 5 wt %, about 4 wt % to about 6 wt %, about 5 wt % to about 7 wt %, about 6 wt % to about 8 wt %, about 7 wt % to about 9 wt %, about 0.02 wt % to about 1 wt %, about 1 wt % to about 2 wt %, about 2 wt % to about 3 wt %, about 3 wt % to about 4 wt %, about 4 wt % to about 5 wt %, about 5 wt % to about 6 wt %, about 6 wt % to about 7 wt %, about 7 wt % to about 8 wt %, or about 8 wt % to about 9 wt %.

The sunflower seed beverage composition also may include at least one (e.g., both) of oleic acid and linoleic acid in the total oil from the comminuted and roasted sunflower seeds in the beverage composition. For example, the sunflower seed beverage composition may include about 0.0044 wt % to about 7.9 wt % oleic acid and about 0.0004 wt % to about 5.5 wt % linoleic acid. More particularly, the sunflower seed beverage composition may include about 0.0044 wt % to about 8 wt %, about 0.0044 wt % to about 3 wt %, about 2 wt % to about 4 wt %, about 3 wt % to about 5 wt %, about 4 wt % to about 6 wt %, about 5 wt % to about 7 wt %, about 6 wt % to about 8 wt %, about 0.0044 wt % to about 1 wt %, about 1 wt % to about 2 wt %, about 2 wt % to about 3 wt %, about 3 wt % to about 4 wt %, about 4 wt % to about 5 wt %, about 5 wt % to about 6 wt %, about 6 wt % to about 7 wt %, or about 7 wt % to about 8 wt % oleic acid. The sunflower seed beverage composition may include any of the amounts of oleic acid provided above and about 0.0004 wt % to about 5.5 wt %, about 0.0004 wt % to about 2 wt %, about 1 wt % to about 3 wt %, about 2 wt % to about 4 wt %, about 3 wt % to about 5 wt %, about 4 wt % to about 6 wt %, about 0.0004 wt % to about 1 wt %, about 1 wt % to about 2 wt %, about 2 wt % to about 3 wt %, about 3 wt % to about 4 wt %, about 4 wt % to about 5 wt %, or about 5 wt % to about 6 wt % linoleic acid.

The amount of water in the sunflower seed beverage composition may include any of the amounts of water provided above in examples of the method of preparing the sunflower seed beverage composition, such as about 81 wt % to about 99.9 wt % water.

The at least one of an anti-caking agent, a gelling agent, a sweetener, one or more vitamins, and/or one or more natural flavors may include any of the anti-caking agents, a gelling agents, sweeteners, one or more vitamins, and/or one or more natural flavors in any of the amounts provided above in examples of the method of preparing the sunflower seed beverage composition. In some embodiments, the sunflower seed beverage composition includes at least an anti-caking agent, such as calcium carbonate. In some embodiments, the sunflower seed beverage composition includes one or more vitamins, such as at least one (e.g., all) of vitamin D2, riboflavin, and/or vitamin B12. In some embodiments, the sunflower seed beverage composition includes the gelling agent, such as gellan gum. In some embodiments, the sunflower seed beverage composition includes as a pH buffer, such as dipotassium phosphate. In some embodiments, the sunflower seed beverage composition includes an emulsifying agent, such as sunflower lecithin. The sunflower seed beverage composition may be free of at least one (e.g., all) of dairy products, gluten, nuts, and/or soy. In other words, at least one (e.g., all) of dairy products, gluten, nuts, oats, peas, sesame, soy, and/or other plant based proteins are absent from the sunflower seed beverage composition. Accordingly, in some embodiments, a sunflower seed beverage composition of this disclosure includes protein only from the heat treated and comminuted sunflower seeds (e.g., the sunflower seed beverage composition is a single-source protein beverage with protein only from the sunflower seeds). Furthermore, conventional processing of sunflower seed compositions include the addition of another vegetable oil, such as sunflower oil, safflower oil, and/or rapeseed/canola oil. In contrast, one or more (e.g., all) of safflower oil and/or rapeseed/canola oil may be absent from the sunflower seed beverage composition. Accordingly, in some embodiments, a sunflower seed beverage composition of this disclosure includes oil only from the heat treated and comminuted sunflower seeds (e.g., the sunflower seed beverage composition is a single-source oil beverage with oil only from the sunflower seeds).

In an example of a sunflower seed beverage composition, the sunflower seed beverage composition may include, per about 240 mL, about 50 calories, about 4.5 g fat, about 0 g saturated fat, about 0 g trans-fat, about 0 mg cholesterol, about 50 mg sodium, about 2 g total carbohydrates, less than about 1 g dietary fiber, about 0 g total sugars, about 2 g protein, about 1.1 mcg vitamin D, about 250 mg calcium, about 0.4 mg iron, about 310 mg potassium, about 2.8 mg vitamin E, about 0.1 mg thiamin, about 0.4 mg riboflavin, about 0.1 mg vitamin B₆, about 0.6 mcg vitamin B₁₂, about 150 mg phosphorous, about 25 mg magnesium, about 0.4 mg zinc, about 4 mcg selenium, about 0.2 mg copper, and/or about 0.1 mg manganese. In some embodiments, a sunflower seed beverage composition may include values that ±10% or ±5% of provided value, per about 240 mL of calories, fat, saturated fat, trans fat, cholesterol, sodium, total carbohydrates, dietary fiber, total sugars, protein, vitamin D, calcium, iron, potassium, vitamin E, thiamin, riboflavin, vitamin B₆, vitamin B₁₂, phosphorous, magnesium, zinc, selenium, copper, and/or manganese.

Features from any of the disclosed embodiments may be used in combination with one another, without limitation. In addition, other features and advantages of the present disclosure will become apparent to those of ordinary skill in the art through consideration of the following detailed description and the accompanying drawings.

As used herein, the term “about” or “substantially” refers to an allowable variance of the term modified by “about” by ±10% or ±5%. Further, the terms “less than,” “or less,” “greater than”, “more than,” or “or more” include as an endpoint, the value that is modified by the terms “less than,” “or less,” “greater than,” “more than,” or “or more.”

While various aspects and embodiments have been disclosed herein, other aspects and embodiments are contemplated. The various aspects and embodiment disclosed herein are for purposes of illustration and are not intended to be limiting.

1. A method of preparing a sunflower seed beverage composition, the method comprising:
roasting hulled sunflower seeds at a temperature of about 10° C. to about 150° C. for about 5 minutes to about 45 minutes;
comminuting the roasted sunflower seeds;
mixing water with the roasted and comminuted sunflower seeds to form a composition;
pasteurizing the composition; and
homogenizing the composition.

2. The method of claim 1, further comprising removing hulls from the sunflower seeds before roasting the hulled sunflower seeds.

3. The method of claim 1, wherein comminuting the roasted sunflower seeds includes comminuting the roasted sunflower seeds to pieces of about 20 microns to about 60 microns.

4. The method of claim 1, wherein mixing water with the heat-treated and comminuted sunflower seeds to form a composition includes mixing water with the roasted and comminuted sunflower seeds to form a composition having about 0.1 wt % to about 14.9 wt % comminuted sunflower seeds and about 81 wt % to about 99.9 wt % water.

5. The method of claim 1, wherein mixing water with the roasted and comminuted sunflower seeds to form a composition includes:
mixing a first amount of the water to the comminuted sunflower seeds to form a paste; and
mixing a second amount of the water to the paste to form the composition.

6. The method of claim 1, further comprising one or more of:
mixing the composition with a gelling agent;
mixing the composition with at least one of a sweetener, one or more vitamins, a food-grade phosphate, and/or one or more natural flavors;
dispensing the sunflower seed beverage composition in at least one of a polyethylene terephthalate bottle, an extended shelf-life container, and/or an aseptic container; or
adding a pH buffer to the composition to such that the composition has a pH of about 7.1 to about 8.0 before pasteurizing and homogenizing the composition.

7. (canceled)

8. The method of claim 1, wherein pasteurizing the composition includes pasteurizing the composition at about 270° F. to about 300° F. for about 2 seconds to about 6 seconds.

9. The method of claim 1, wherein homogenizing the composition includes:
homogenizing the composition at a first phase of about 2000 psi to about 2200 psi; and
homogenizing the composition at a second phase of about 500 psi to about 1000 psi after homogenizing the composition at the first phase.

10. (canceled)

11. The method of claim 1, further comprising selecting the hulled sunflower seeds having at total oil content of about 20 wt % to about 60 wt %, an oleic acid content of about 22 wt % to about 88 wt % of the total oil content, and a linoleic acid content of about 2 wt % to about 62 wt % of the total oil content.

12. (canceled)

13. The method of claim 1, wherein pasteurizing the composition is performed before homogenizing the composition.

14. The method of claim 1, wherein homogenizing the composition is performed before pasteurizing the composition.

15. A sunflower seed beverage composition formed by roasting hulled sunflower seeds at a temperature of about 10° C. to about 150° C. for about 5 minutes to about 45 minutes, comminuting the heat treated sunflower seeds, mixing water with the heat treated and comminuted sunflower seeds to form a composition, pasteurizing the composition, and homogenizing the composition.

16. A sunflower seed beverage composition, comprising:
about 0.1 wt % to about 14.9 wt % roasted and comminuted sunflower seeds;
about 81 wt % to about 99.9 wt % water;
a pH of about 7.1 to about 8.0; and
at least one of an anti-caking agent, a gelling agent, a sweetener, one or more vitamins, a food-grade phosphate, and/or one or more natural flavors.

17. The sunflower seed beverage composition of claim 16, wherein the roasted and comminuted sunflower seeds are roasted at a temperature of about 10° C. to about 150° C. for about 5 minutes to about 45 minutes before mixing with the water.

18. The sunflower seed beverage composition of claim 16, wherein the roasted and comminuted sunflower seeds are sized about 20 microns to about 60 microns.

19. (canceled)

20. (canceled)

21. (canceled)

22. (canceled)

23. The sunflower seed beverage composition of claim 16, wherein the sunflower seed beverage composition includes sunflower lecithin as an emulsifying agent.

24. The sunflower seed beverage composition of claim 16, wherein the sunflower seed beverage composition includes about 0.02 wt % to about 8.9% total oil content, about 0.0044 wt % to about 7.9 wt % oleic acid, and about 0.0004 wt % to about 5.5 wt % linoleic acid.

25. The sunflower seed beverage composition of claim 16, wherein dairy products, oats, peas, sesame, gluten, nuts, and soy are absent from the sunflower seed beverage composition.

26. The sunflower seed beverage composition of claim 16, wherein protein present in the sunflower seed beverage composition is derived only from the roasted and comminuted sunflower seeds.

27. The sunflower seed beverage composition of claim 16, wherein oil present in the sunflower seed beverage composition is derived only from the roasted and comminuted sunflower seeds.

28. (canceled)
